(19) United States
(12) Patent Application Publication
(10) Pub. No.: US 2011/0033720 A1
(43) Pub. Date: Feb. 10, 2011

(54) TRANSPARENT ADHESIVE SHEET AND IMAGE DISPLAY DEVICE INCLUDING THE SAME

(76) Inventors: Jun Fujita, Tokyo (JP); Hikaru Takeda, Tokyo (JP); Yorinobu Takamatsu, Kanagawa (JP); Toshihiro Suwa, Kanagawa (JP); Shunsuke Suzuki, Tokyo (JP); Hiroyuki Kobayashi, Kanagawa (JP)

Correspondence Address: 3M INNOVATIVE PROPERTIES COMPANY, PO BOX 33427, ST. PAUL, MN, 55133-3427, US

(21) Appl. No.: 12/935,936

(22) PCT Filed: Apr. 3, 2009
(86) PCT No.: PCT/US09/39465

§ 371 Date: Oct. 1, 2010

(30) Foreign Application Priority Data
Apr. 11, 2008 (JP) 2008-103994
Dec. 15, 2008 (JP) 2008-318842

(51) Int. Cl. C08F 220/10; B32B 27/36

(52) U.S. Cl. 428/522; 526/328.5

(57) ABSTRACT

An object of the present disclosure is to provide a transparent adhesive sheet in which the occurrence of display unevenness, bubbles and peeling is prevented. The transparent adhesive sheet contains a copolymer of a monomer comprising (A) an alkyl (meth)acrylate having an alkyl group of 4 to 18 carbon atoms, a polar monomer whose homopolymer has a glass transition temperature (Tg) of 50 C or higher (B), and (C) a (meth)acrylate ester, wherein the copolymer exhibits tan of 0.13 or more at 140 C and 1.0 Hz, and also exhibits a storage elastic modulus of 8.9 104 Pa or less at 25 C and 1.0 Hz.

### TECHNICAL FIELD

The present disclosure relates to a transparent adhesive sheet, and an image display device including the same.

### BACKGROUND

There has recently proposed a method in which permeability is improved and decreases in the brightness and contrast of an image display device are suppressed by replacing a gap between a surface protective layer or a touch panel and a display surface of an image display unit, or the surface protective layer and the touch panel in the image display device, by a transparent substance having a refractive index close to that of the surface protective layer, the touch panel and the display surface of the image display unit when compared with air. Examples of the transparent substance include transparent polymer materials such as a transparent resin sheet, a pressure-sensitive adhesive (adhesive) and a curable adhesive (for example, silicone gel).

Japanese Unexamined Patent Publication (Kokai) No. 09-197387 describes a method for producing a liquid crystal display device in which a viewing side of a liquid crystal display panel is tightly adhered with a transparent protective plate via a transparent resin sheet made of a plasticizer-containing polymer as a transparent polymer material in a state where a volatile liquid is disposed between the transparent resin sheet and one or both of the liquid crystal display panel or the transparent protective plate via the transparent resin sheet.

Japanese Unexamined Patent Publication (Kokai) No. 06-59253 describes a method for producing a liquid crystal display device in which a reaction curable silicone gel, which is a colorless transparent elastic resin, is used as a transparent polymer material between a liquid crystal display panel and a glass plate. The colorless transparent elastic resin is cured after pouring in a liquid state, thereby fixing the liquid crystal display panel and the glass plate.

Japanese Unexamined Patent Publication (Kokai) No. 2005-200540 describes an adhesive composition including a (meth)acrylic (co)polymer containing 51 to 100% by weight of an alkylene oxide (meth)acrylate adduct, 0 to 49% by weight of another (meth)acrylic monomer and 0 to 49% by weight of another polymerizable monomer as monomer components, and an adhesive composition containing a crosslinking agent, and a surface protective film including a supporting film and an adhesive layer made of the crosslinked adhesive composition formed on the supporting film.

Japanese Unexamined Patent Publication (Kokai) No. 2006-111846 describes an adhesive composition including a (meth)acrylic polymer containing 5 to 100% by weight of an alkylene oxide (meth)acrylate adduct, 0 to 95% by weight of the other (meth)acrylic monomer having an alkyl group having 1 to 14 carbon atoms and 0 to 95% by weight of another polymerizable monomer as monomer components, and an alkali metal salt, wherein the (meth)acrylic polymer has an acid value of 10 or less, and an adhesive sheet including a support and an adhesive layer made of the crosslinked adhesive composition formed on one or both surfaces of the support.

Japanese Unexamined Patent Publication (Kokai) No. 2008-1739 describes an adhesive composition for an electronic display, including a copolymer and/or a mixture of an alkyl (meth)acrylate monomer and a carboxyl group-containing monomer, which further includes a monomer having an alkyleneoxy group and a hydroxyl group-containing (meth)acrylate monomer, and an adhesive layer for electronic display, including the composition.

### SUMMARY

Use of an acrylic adhesive sheet as a transparent substance has been studied since the production process is simple when compared with a liquid curable adhesive and the acrylic adhesive sheet displays excellent optical characteristics such as transparency and displays excellent adhesion characteristics when compared with a silicone gel. However, when a conventional acrylic resin sheet is applied to a recent small-sized thin type image display device, there sometimes arose a phenomenon that color or brightness varies at a portion of an image plane in the image display device, that is, display unevenness results. Particularly when a surface protective layer in the image display device has an irregular shape and an adhesive sheet is applied to the surface having an irregular shape (i.e., a surface having concave-convex shape or a pattern indented surface), or when an adhesive sheet is applied to a display surface of an image display unit (for example, a polarizing plate) including a layer having an irregular shape such display unevenness should be solved. There is a need for a transparent adhesive sheet in which display unevenness is not generated, and also in which neither bubbles nor peeling do not occur at the interface between a surface protective layer in the image display device and a display surface of an image display unit or a touch panel (hereinafter may be referred to as the “adherend”) even when allowed to stand in a high-temperature and high-humidity state, and also in which whitening does not occur.

According to one aspect of the present disclosure, there is provided a transparent adhesive sheet for applying a surface protective layer or a touch panel in an image display device to a display surface of an image display unit, or applying the surface protective layer to the touch panel, wherein the transparent adhesive sheet contains a copolymer of a monomer including:

(A) an alkyl (meth)acrylate having an alkyl group of 4 to 18 carbon atoms,

(B) a polar monomer whose homopolymer has a glass transition temperature (Tg) of 50° C. or higher, and

(C) a (meth)acrylate ester (C-1) represented by the following formula (1), or a hydrophilic monomer (C-2) whose homopolymer has a glass transition temperature (Tg) of 10° C. or lower (which is a monomer other than the component (C-1) and a mass ratio of the component (B) to the component (C-2) is from 4:10 to 4:1):

CH₂═C(R)COO-(AO)ₚ—(BO)_{q}—R′ (1)

wherein, in the formula (1),

A is at least one kind of a group selected from the group consisting of (CH₂)ᵣCO, CH₂CH₂, CH₂CH(CH₃) and CH₂CH₂CH₂CH₂,

B is at least one kind of a group selected from the group consisting of (CH₂)ᵣCO, CO(CH₂)ᵣ, CH₂CH₂, CH₂CH(CH₃) and CH₂CH₂CH₂CH₂,

R is hydrogen or CH₃,

R′ is hydrogen, or a substituted or unsubstituted alkyl or aryl group,

p, q and r each represents an integer of 1 or more, and wherein the copolymer exhibits tan δ of 0.13 or more at 140° C. and 1.0 Hz, and also exhibits a storage elastic modulus of 8.9×10⁴ Pa or less at 25° C. and 1.0 Hz.

According to still another aspect of the present disclosure, an image display unit, and an image display device including the above transparent adhesive sheet and a surface protective layer are provided.

As used herein, the wording “tan δ at 140° C. and 1.0 Hz” means loss tangent represented by a ratio of a storage elastic modulus G′ (Pa) to a loss elastic modulus G″ (Pa) in a shear mode at a frequency of 1.0 Hz and a temperature of 140° C.

The term “storage elastic modulus at 25° C. and 1.0 Hz” as used herein means a storage elastic modulus at 25° C. when viscoelasticity is measured in a shear mode at a temperature within a range from −60° C. to 200° C., a rate of temperature increase of 5° C./minute and 1.0 Hz.

The term “glass transition temperature (Tg)” of a homopolymer as used herein means a temperature in the case where a state varies from a supercooled liquid to a glass state when a heat-melted polymer is cooled under certain conditions. In the present specification, Tg is specifically a value measured according to JIS K7121.

The term “polar monomer” as used herein means a monomer having a polar group such as hydroxyl group, carboxyl group, amide group, or amino group.

The term “(meth)acrylic” used in the present specification as used herein means “acrylic” or “methacrylic”.

When the transparent adhesive sheet provided as one aspect of the present disclosure is used for application of a surface protective layer or a touch panel to a display surface of an image display unit in an image display device, or application of the surface protective layer to the touch panel, display unevenness does not occur. Particularly when the transparent adhesive sheet is applied to a surface protective layer having an irregular shape, or even when the transparent adhesive sheet is applied to a display surface of an image display unit including a layer having an irregular shape (for example, a polarizing plate), the occurrence of display unevenness can be prevented.

When the transparent adhesive sheet is applied to a surface protective layer in an image display device, or a display surface of an image display unit or a touch panel, bubbles are not generated at the interface between those units even under a high-temperature and high-humidity environment. Furthermore, after application of a surface protective layer or a touch panel in an image display device to a display surface of an image display unit, peeling of the surface protective layer and the touch panel can also be suppressed.

Furthermore, the transparent adhesive sheet can prevent whitening in the image display device.

### BRIEF DESCRIPTION OF THE DRAWINGS

FIG. 1 shows a sectional view of one aspect of an image display device including a transparent adhesive sheet of the present disclosure.

FIG. 2 shows a sectional view of another aspect of an image display device including a transparent adhesive sheet of the present disclosure.

FIG. 3 shows a sectional view of another aspect of an image display device including a transparent adhesive sheet of the present disclosure.

FIG. 4 shows a sectional view of another aspect of an image display device including a transparent adhesive sheet of the present disclosure.

### DETAILED DESCRIPTION

The transparent adhesive sheet to be provided as one aspect of the present disclosure is used so as to apply a surface protective layer or a touch panel in an image display device to a display surface of an image display unit, or to apply the surface protective layer to the touch panel. As used herein, the transparent adhesive sheet contains a copolymer of a monomer including (A) an alkyl (meth)acrylate having an alkyl group of 4 to 18 carbon atoms, (B) a polar monomer whose homopolymer has a glass transition temperature (Tg) of 50° C. or higher, and (C) (C-1) a (meth)acrylate ester represented by the following formula (1), or (C-2) a hydrophilic monomer whose homopolymer has a glass transition temperature (Tg) of 10° C. or lower (which is a monomer other than the component (C-1), and a mass ratio of the component (B) to the component (C-2) is from 4:10 to 4:1):

CH₂═C(R)COO-(AO)ₚ—(BO)_{q}—R′ (1)

wherein, in the formula (1), A, B, R, R′, p, q are as defined above.

As used herein, an alkyl (meth)acrylate having an alkyl group of 4 to 18 carbon atoms as the component (A) can impart suitable adhesion to the resulting adhesive sheet and can improve wettability to the adherend.

Regarding the alkyl (meth)acrylate having an alkyl group of 4 to 18 carbon atoms as the component (A), in view of imparting sufficient adhesion (flexibility) to the resulting adhesive sheet using the component (A) alone, a glass transition temperature of a polymer of one or plural kinds of monomer used as the component (A) is preferably 25° C. or lower. Specifically, it is possible to use a monomer whose homopolymer has a glass transition temperature of 25° C. or lower, for example, an alkyl (meth)acrylate such as n-butyl acrylate, isobutyl acrylate, isoamyl acrylate, hexyl acrylate, cyclohexyl acrylate, 2-ethylhexyl (meth)acrylate, isooctyl (meth)acrylate, isononyl (meth)acrylate, n-decyl (meth)acrylate, isodecyl (meth)acrylate, lauryl (meth)acrylate, isomyristyl (meth)acrylate, isocetyl (meth)acrylate or isostearyl (meth)acrylate, or a mixture thereof.

Among the above, the component (A) is preferably an alkyl acrylate since it has excellent polymerizability in any of polymerization methods such as thermopolymerization and photopolymerization methods. Specific examples thereof include n-butyl acrylate, isobutyl acrylate, 2-ethylhexyl acrylate, isooctyl acrylate, isononyl acrylate, isodecyl acrylate, lauryl acrylate, isomyristyl acrylate, isocetyl acrylate and isostearyl acrylate. In view of adhesion, 2-ethylhexyl acrylate, isooctyl acrylate and isocetyl acrylate are particularly preferable.

When the component (C-2) described hereinafter is used as the component (C), an alkyl (meth)acrylate having an alkyl group of 4 to 12 carbon atoms is preferably used as the component (A) in view of adhesion.

In addition to the monomers described above, an alkyl (meth)acrylate monomer having an alkyl group of 4 to 18 carbon atoms whose homopolymer has a glass transition temperature of 25° C. or higher may also be used. Examples of the alkyl (meth)acrylate having an alkyl group of 4 to 18 carbon atoms whose homopolymer has a glass transition temperature of 25° C. or higher include linear or branched alkyl (meth)acrylates such as t-butyl (meth)acrylate, n-butyl methacrylate and isobutyl methacrylate; and alicyclic alkyl (meth)acrylates such as cyclohexyl methacrylate, 4-t-butylcyclohexyl (meth)acrylate and isobornyl (meth)acrylate. When the alkyl (meth)acrylate having an alkyl group of 4 to 18 carbon atoms monomer whose homopolymer has a glass transition temperature of 25° C. or higher is used, a glass transition temperature of a polymer of plural kinds of monomers used as the component (A) is preferably 25° C. or lower.

As described above, the glass transition temperature of the polymer of one or plural kinds of monomers as the component (A) can be measured according to JIS K7121.

Next, a polar monomer whose homopolymer has a glass transition temperature (Tg) of 50° C. or higher as the component (B) increases a cohesive force of the resulting transparent adhesive sheet and imparts adhesion. Therefore, when the resulting transparent adhesive sheet is applied for an image display device, foaming and peeling at a high temperature are prevented.

Examples of the polar monomer whose homopolymer has a glass transition temperature (Tg) of 50° C. or higher as the component (B) include ethylenically unsaturated monomers having a functional group, such as carboxylic acid and sulfonic acid; and substituted acrylamides such as vinylestr, vinylamide, N-vinyllactam and (meth)acrylamide. Specific examples thereof include, but are not limited to, acrylic acid, methacrylic acid, itaconic acid, maleic acid, maleimide, styrenesulfonic acid, acryloyloxyethyl phthalate, acryloyloxypropyl phthalate, substituted acrylamides such as N,N-dimethyl(meth)acrylamide, N,N-diethyl(meth)acrylamide, N-t-butyl(meth)acrylamide, N,N-isopropyl(meth)acrylamide, N-t-octyl(meth)acrylamide, N,N-dimethylaminoethyl(meth)acrylamide, N, N-dimethylaminopropyl(meth)acrylamide and diacetoneacrylamide, (meth)acrylonitrile, N-vinyl pyrrolidone and N-vinylcaprolactam. Among these, a monomer having high polarity is preferred in view of a cohesive force, and a hydrophilic monomer is specifically preferred. As used herein, the term “hydrophilic monomer” means a monomer which is excellent in affinity with water and is dissolved in the amount of 5 g or more based on 100 g of water. Examples of the hydrophilic monomer include acrylic acid, or a substituted acrylamide (particularly preferably, diacetoneacrylamide).

Subsequently, the component (C) is described. The component (C) controls moisture permeability of the resulting transparent adhesive sheet. It becomes possible to obtain high flexibility and adhesion force by using the component (C) in addition to the components (A) and (B) described above without impairing hydrophilicity of the resulting transparent adhesive sheet (copolymer). As the component (C), the following component (C-1) or component (C-2) is used.

A (meth)acrylate ester as the component (C-1) is represented by the following formula (1):

CH₂═C(R)COO-(AO)ₚ—(BO)_{q}—R′ (1)

wherein, in the formula (1),

A is at least one kind of a group selected from the group consisting of (CH₂)ᵣCO, CH₂CH₂, CH₂CH(CH₃) and CH₂CH₂CH₂CH₂. In view of control of moisture permeability of the resulting transparent adhesive sheet and industrial availability, CH₂CH₂ or CH₂CH(CH₃) is preferred.

B is at least one kind of a group selected from the group consisting of (CH₂)ᵣCO, CO(CH₂)ᵣ, CH₂CH₂, CH₂CH(CH₃) and CH₂CH₂CH₂CH₂. Similar to A, in view of control of moisture permeability of the resulting transparent adhesive sheet and industrial availability, CH₂CH₂ or CH₂CH(CH₃) is preferred.

R is hydrogen or CH₃. When copolymerization is conducted by photopolymerization, R is preferably H in view of polymerization.

R′ is hydrogen, or a substituted or unsubstituted alkyl or aryl group, and the alkyl or aryl group may be linear, branched or cyclic. In a certain aspect, an alkyl group (specifically, methyl group, ethyl group, butyl group, octyl group) having excellent compatibility with the component (A) is used.

p, q and r each represents an integer of 1 or more. Although there is no particular limitation on the upper limit, compatibility with the component (A) can be improved when p is 10 or less, q is 10 or less, and r is 5 or less.

In view of foaming resistance upon moist heating of the resulting transparent adhesive sheet, the component (C-1) is preferably a polyalkylene glycol alkyl ether acrylate of the formula (1) in which R is hydrogen, R′ is an alkyl group having 1 to 12 carbon atoms, and 2≦p+q≦10.

Specific examples thereof include polyalkylene glycol mono (meth)acrylates having a hydroxyl group at the end, such as polyethylene glycol acrylate (Blenmer AE series, manufactured by NOF CORPORATION), polyethylene glycol methacrylate (Blenmer PE series, manufactured by NOF CORPORATION), polyethylene glycol polypropylene glycol acrylate (Blenmer AEP series, manufactured by NOF CORPORATION), polypropylene glycol acrylate (Blenmer AP series, manufactured by NOF CORPORATION), polypropylene glycol methacrylate (Blenmer PP series, manufactured by NOF CORPORATION) and polypropylene glycol polytetramethylene glycol acrylate (Blenmer APT series, manufactured by NOF CORPORATION); polyalkylene glycol alkyl ether (meth)acrylates having an alkyl group at the end, such as methylpolyethylene glycol (meth)acrylate, methyldipropylene glycol (meth)acrylate, ethoxyethoxy ethyl (meth)acrylate, diethylene glycol 2-ethylhexyl ether (meth)acrylate, diethylene glycol decanol ether (meth)acrylate and diethylene glycol lauryl ether (meth)acrylate; polyalkylene glycol aryl ether (meth)acrylates having an aryl group at the end, such as phenoxydiethylene glycol (meth)acrylate and nonylphenoxypolyethylene glycol (meth)acrylate; polyester mono(meth)acrylates such as β-carboxyethyl acrylate, ω-carboxypolycaprolactone acrylate (M-5300, manufactured by TOAGOSEI CO., LTD.), caprolactone-modified tetrahydrofurfuryl acrylate (KAYARAD TC110S, manufactured by NIPPON KAYAKU CO., LTD.), ethyldiethylene glycol oligoacrylate (Biscoat 190D, manufactured by Osaka Organic Chemical Industry Ltd. and a mixture of CH₂═CHCOO—(CH₂CH₂O)₂—CH₂CH₃ and CH₂═CHCOO—(CH₂CH₂COO)ₙ—(CH₂CH₂O)₂—CH₂CH₃ (25:75 (weight ratio)); and modified compounds thereof. Two or more kinds of these (meth)acrylate esters may be used in combination.

The component (C-2) is a hydrophilic monomer whose homopolymer has a glass transition temperature (Tg) of 10° C. or lower. The component (C-2) is a monomer other than the component (C-1) and is used in the amount such that a mass ratio of the component (B) to the component (C-2) is from 4:10 to 4:1. When the mass ratio of the component (B) to the component (C-2) is from 4:10 to 4:1, it becomes possible to maintain hydrophilicity while maintaining a low elastic modulus of the copolymer and to preferably control adhesion to the adherend.

Examples of the hydrophilic monomer whose homopolymer has a glass transition temperature (Tg) of 10° C. or lower as the component (C-2) include a hydroxyalkyl acrylate having an alkyl group of 4 or less carbon atoms, and a (meth)acrylic compound having an oxyethylene group or an oxypropylene group, or a polyoxyethylene group or a polyoxypropylene group. Specific examples thereof include, but are not limited to, 2-hydroxyethyl acrylate and hydroxypropyl acrylate. Among these, in view of imparting flexibility to the transparent adhesive sheet, the hydrophilic monomer is preferably a hydrophilic monomer whose homopolymer has a glass transition temperature (Tg) of 0° C. or lower, and more preferably a hydrophilic monomer whose homopolymer has a glass transition temperature of −5° C. or lower, and includes, for example, 2-hydroxyethyl acrylate and 2-hydroxypropyl acrylate.

In view of foaming resistance under a high-temperature and high-humidity environment, the component (C) is preferably a component (C-1).

The copolymer obtained from the monomer containing the component (A), component (B) and component (C) exhibits tan δ of 0.13 or more at 140° C. and 1.0 Hz, and also exhibits a storage elastic modulus of 8.9×10⁴ Pa or less at 25° C. and 1.0 Hz. Such dynamic viscoelasticity characteristics are important in view of liquid crystal unevenness in the transparent adhesive sheet of the present disclosure. Specifically, the appearance of liquid crystal unevenness in the transparent adhesive sheet is involved in both stress relaxation properties and initial residual stress of the copolymer.

Herein, data of tan δ and storage elastic modulus (dynamic viscoelasticity characteristics) can be measured by using a viscoelasticity measuring device, for example, Advances Rheometric Expansion System (ARES) manufactured by Rheometric Scientific, Inc. Dynamic viscoelasticity depends on the measuring temperature and the measuring frequency. Therefore, when the storage elastic modulus in the present disclosure is a storage elastic modulus G′ (Pa) in a shear mode at a frequency of 1.0 Hz and 25° C., the loss elastic modulus tan δ (G″/G′) is taken as an indicator having a value determined from a storage elastic modulus G′ (Pa) and a loss elastic modulus G″ (Pa) in a shear mode at a frequency of 1.0 Hz and 140° C.

Tan δ is an indictor of stress relaxation properties in the transparent adhesive sheet. When tan δ of the copolymer is 0.13 or more, the resulting transparent adhesive sheet is excellent in stress relaxation properties and is free from display unevenness. Tan δ is preferably 0.15 or more, and more preferably 0.2 or more. There is no particular limitation on the upper limit of tan δ. However, when the value of tan δincreases, heat resistance (adhesion at a high temperature) of the copolymer usually deteriorates and foaming (i.e., formation of bubbles) is likely to occur when formed into a transparent adhesive sheet. Therefore, tan δ at 140° C. and 1.0 Hz of the copolymer can be usually adjusted to 0.6 or less.

The storage elastic modulus is an indicator of residual stress (initial residual stress) of the transparent adhesive sheet deformed upon lamination. When this value is 8.9×10⁴ Pa or less, display unevenness can be suppressed. For example, even when the transparent adhesive sheet is laminated on the adherend with a surface having an irregular shape of about 10 μm, it becomes possible to suppress display unevenness. Furthermore, when the storage elastic modulus is adjusted to 7.4×10⁴ Pa or less, it becomes possible to reduce unevenness even when the transparent adhesive sheet is laminated on the adherend with a surface having large unevenness or a complicated irregular shape.

The tan δ and storage elastic modulus of the copolymer can be adjusted by appropriately varying the kind, molecular weight and composition of the component (A), component (B) and component (C). For example, when a large amount of the component (B) is used, the storage elastic modulus increases. When the amount of the component (A) and component (C) increases, the storage elastic modulus can be decreased. When the molecular weight of the copolymer of the monomer containing the component (A), component (B) and component (C) increases, the storage elastic modulus tends to increase. The component (C) has the function of suppressing foaming of the resulting transparent adhesive sheet even when tan δ of the copolymer increases. Herein, tan δ of the copolymer can be adjusted by the amount of a crosslinking agent described hereinafter. Specifically, when the amount of the crosslinking agent is increased, the value of tan δ decreases. In contrast, when the amount of the crosslinking agent is decreased, the value of tan δ increases.

In the copolymer, the amounts of the component (A), component (B) and component (C) can be respectively adjusted to 40 to 90% by mass, 1 to 15% by mass and 5 to 50% by mass, based on the total amount of the monomer. When the amount of the component (A) increases to 90% by mass or more, an adhesion force of the resulting adhesive sheet may decrease. In contrast, when the amount decreases to 40% by mass or less, the elastic modulus increases and thus wettability of the copolymer to the adherend may become worse.

When the component (C-2) is used as the component (C), the amount of the component (A) is preferably adjusted within a range from 80 to 90% by mass based on the total amount of the monomer and the total amount of the component (B) and component (C) (component (C-2)) is preferably adjusted within a range from 20 to 10% by mass based on the total amount of the monomer, in view of the adhesion force and elastic modulus of the resulting adhesive sheet. As described above, a mass ratio of the component (B) to the component (C-2) is from 4:10 to 4:1.

The transparent adhesive sheet (copolymer) obtained from the copolymer of the monomer components (A), (B) and (C), which has the above dynamic viscoelasticity characteristics, can achieve sufficient flexibility and adhesion force without impairing hydrophilicity. By using such a transparent adhesive sheet having high flexibility, even when the transparent adhesive sheet is applied to a display surface of an image display unit provided with a surface protective layer having an irregular shape or a layer having an irregular shape (for example, a polarizing plate), it is possible to absorb irregularity, thus making it possible to prevent the appearance of the display unevenness in an image display device. Even when the thickness of the sheet itself varies, it is possible to laminate with a surface of the adherend without forming a gap since the sheet has high flexibility, and thus the appearance of display unevenness in the image display device can be prevented.

In the transparent adhesive sheet, adhesion of the transparent adhesive sheet to the adherend can be adjusted to 5 N/25 mm or more (measured by a 90 degree peeling test at a rate of 300 mm/minute). In a certain aspect, adhesion of the transparent adhesive sheet to the adherend can be adjusted to 10 N/25 mm or more, or 15 N/25 mm or more (measured by a 90 degree peeling test at a rate of 300 mm/minute) and thus sufficient adhesion between the transparent adhesive sheet and the adherend is obtained. Therefore, even under a high-temperature and high-humidity environment, bubbles are not generated at the interface between the transparent adhesive sheet having such an adhesion force and the adherend, and also peeling after application can be suppressed. According to such a transparent adhesive sheet, a sufficient adhesion force can be attained even when applied to a surface protective layer composed of a polymer film made of polymethyl methacrylate (PMMA).

Furthermore, the transparent adhesive sheet has hydrophilicity and therefore it can absorb moisture and can prevent whitening in the image display device. The degree of prevention of whitening (transparency) can be expressed by a haze value. Herein, the haze value can be measured as a haze value of a laminate obtained by laminating the transparent adhesive sheet on the transparent adherend (for example, a surface protective layer of an image display device) according to JIS K 7136. The haze value may be measured by the following environmental test. Namely, the resulting laminate is allowed to stand under an environment at a temperature of 60° C. and a relative humidity (RH) of 90% for 3 days and then the haze value of the laminate after standing for 3 days is measured. When the haze value of the laminate obtained by laminating a surface protective layer of an image display device on the transparent adhesive sheet is 2 or less, it is possible to judge that no whitening arises.

Furthermore, the transparent adhesive sheet has excellent transparency. Namely, when the transparent adhesive sheet is laminated on a transparent adherend (for example, a surface protective layer of an image display device) to form a laminate, a total light transmittance (JIS K 7361) at a visible light wavelength range of the resulting laminate becomes 90% or more.

The copolymer of the monomer can be crosslinked using a crosslinking agent so as to secure cohesiveness. When the copolymer contains the crosslinking agent, the amount is usually adjusted to 2 parts by mass or less based on 100 parts by mass of the total mass of the component (A), component (B) and component (C), in view of stress relaxation properties and foaming. In a certain aspect, the amount may be adjusted to 1 part by mass or less. There is no limitation on the lower limit of the amount of the crosslinking agent. When the crosslinking agent is added in the amount of about 0.01 part by mass based on 100 parts by mass of the total mass of the component (A), component (B) and component (C), handling properties of the copolymer are improved.

The copolymer may have a group capable of forming a crosslinked structure in the copolymer (crosslinkable group) so as to form a crosslink. The crosslinkable group may be a functional group having reactivity with a crosslinking agent such as a polyfunctional isocyanate, epoxy or aziridine compound and includes, for example, a hydroxyl group. Specifically, when a hydroxyl group exists in the copolymer, the hydroxyl group reacts with a polyfunctional isocyanate to form a crosslink through a urethane bond. In order to incorporate the crosslinkable group in the copolymer, 2-hydroxyethyl acrylate, 2-hydroxyethyl methacrylate or 2-hydroxypropyl acrylate may be used as a monomer component.

The crosslinkable group may be a radical polymerizable group such as a (meth)acryloyl group. In this case, since the crosslinking reaction simultaneously arises upon production (polymerization) of the copolymer, it is not necessary to separately add a crosslinking agent. Examples of the monomer having such a group include polyfunctional (meth)acrylate monomers such as 1,2-ethylene glycol di(meth)acrylate, 1,4-butanediol di(meth)acrylate and 1,6-hexanediol di(meth)acrylate.

The monomer component to be used in the copolymer contained in the transparent adhesive sheet may contain a monomer component other than the components (A), (B) and (C) as long as characteristics of the transparent adhesive sheet are not impaired. Examples thereof include acrylic monomers other than the components (A), (B) and (C), such as benzyl acrylate, pentamethylpiperidyl methacrylate, N,N-dimethylaminoethyl acrylate, N-diethylaminoethyl acrylate, N,N-dimethylaminopropyl acrylate, N,N-dimethylaminopropylacrylamide, N-acryloyloxyethylhexahydrophthalimide, trifluoroethyl methacrylate, methacrylic acid-modified silicone oil, 3-methacryloxypropylmethyldimethoxysilane, 3-methacryloxypropyltrimethoxysilane, 3-methacryloxypropylmethyldiethoxysilane, 3-methacryloxypropyltriethoxysilane and 3-acryloxypropyltrimethoxysilane; and vinyl monomers such as vinyl acetate, vinyl propionate, vinyl versatate, styrene, vinylpyridine and vinylimidazole.

The copolymer can be formed by polymerizing the monomer component in the presence of a polymerization initiator. There is no particular limitation on a polymerization method and the monomer may be polymerized according to a usual radical polymerization method, for example, a solution polymerization, emulsion polymerization, suspension polymerization or bulk polymerization method. In a certain aspect, a radical polymerization method using a thermopolymerization initiator may be employed. Examples of the thermopolymerization initiator include organic peroxides such as benzoyl peroxide, t-butyl perbenzoate, cumen hydroperoxide, diisopropyl peroxydicarbonate, di-n-propyl peroxydicarbonate, di(2-ethoxyethyl) peroxydicarbonate, t-butyl peroxyneodecanoate, t-butyl peroxypivalate, (3,5,5-trimethylhexanoyl) peroxide, dipropionyl peroxide and diacetyl peroxide; and azo-based compounds such as 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methyl propionate), 4,4′-azobis(4-cyanovaleric acid), 2,2′-azobis(2-hydroxymethylpropionitrile) and 2,2′-azobis[2-(2-imidazolin-2-yl)propane].

In another aspect, the copolymer can be prepared by photopolymerization using a suitable polymerization initiator. Specifically, there is exemplified a polymerization method in which a monomer component is polymerized by irradiating the above monomer with ultraviolet ray (UV) in the presence of a photopolymerization initiator. Examples of suitable polymerization initiator include acetophenone, diethoxyacetophenone, 2-[4-(methylthio)-methyl-1-phenyl]-2-morpholino propanone, benzoin, benzoin ethyl ether, benzyl methyl ketal, benzophenone, 2-ethylanthraquinone, thioxanthone, diethylthioxanthone, 2,4,6-trimethylbenzoyl diphenylphosphine oxide (Lucirin™ TPO, manufactured by BASF), 2,4,6-trimethylbenzoyl diethoxyphosphine oxide (Lucirin™ TPO-L, manufactured by BASF), bis(2,4,6-trimethylbenzoyl)phenylphosphine (IRGACURE™ 819, manufactured by Ciba Japan K.K.), 2-hydroxy-2-methyl-1-phenylpropan-1-one (DAROCURE™ 1173, manufactured by Ciba Japan K.K.), 4-(2-hydroxyethoxy)phenyl(2-hydroxy-2-propyl)ketone (IRGACURE™ 2959, manufactured by Ciba Japan K.K.), 4-(2-acryloyloxyethoxy)phenyl-(2-hydroxy-2-propyl)ketone, 1-hydroxycyclohexyl phenyl ketone (IRGACURE™ 184, manufactured by Ciba Japan K.K.), 1-(4-isopropylphenyl)-2-hydroxy-2-methylpropan-1-one, 1-(4-dodecylphenyl)-2-hydroxy-2-methylpropan-1-one, 2-methyl-2-morpholino(4-thiomethylphenyl)propan-1-one (IRGACURE™ 907, manufactured by Ciba Japan K.K.), 2-benzyl-2-dimethylamino-1-(4-morpholinophenyl)-butanone (IRGACURE™ 369, manufactured by Ciba Japan K.K.), N,N′-octamethylenebisacridine (ADEKA Optomer™ N1717) and acryloylbenzophenone (DAICEL UCB Ebercryl™ P36).

The transparent adhesive sheet may contain, in addition to the above copolymers, other components such as dyes, pigments, UV absorbers, other fillers and antioxidants. When the adherend is an inorganic material such as glass and ITO, a silane coupling agent is preferably used. However, the copolymer itself has characteristics required as the transparent adhesive sheet and therefore can be used as it is for application of a surface protective layer or a touch panel to a display surface of an image display unit in an image display device, or application of the surface protective layer to the touch panel even when it does not contain additives such as plasticizers and tackifiers. Therefore, when the copolymer is used as it is as the transparent adhesive sheet, contamination by bleed of components other than the copolymer, and a change in characteristics of the transparent adhesive sheet do not occur.

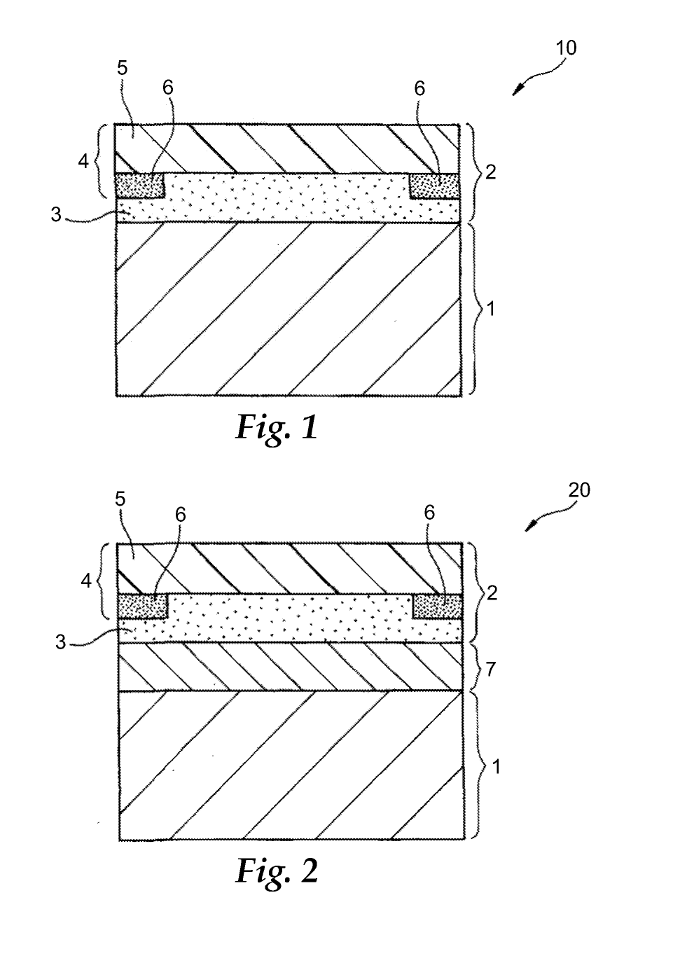

The thickness of the transparent adhesive sheet is not particularly limited as long as it does not adversely affect mounting to the image display device (application of a surface protective layer or a touch panel to a display surface of an image display unit in an image display device, or application of the surface protective layer to the touch panel). For example, the thickness can be adjusted within a range from 0.025 to 1 mm. When the thickness of the transparent adhesive sheet increases, adhesion to the adherend (polymer film made of PMMA, or glass plate, etc.) increases. Subsequently, an image display device including the above transparent adhesive sheet is described with reference to FIGS. 1 to 4. Herein, the image display device includes an image display unit, a transparent adhesive sheet and a surface protective layer. Regarding the transparent adhesive sheet included in the image display device, internal residual stress in the transparent adhesive sheet is relaxed.

Examples of the image display unit include, but are not limited to, image display units such as reflection type or backlight type liquid crystal display unit, plasma display unit, electroluminescent (EL) display and electronic paper. On a display surface of the image display unit, an additional layer (may be either a single layer or a multi layer), for example, a polarizing plate (which may have a surface having an irregular shape) can be provided. A touch panel described hereinafter may exist on a display surface of the image display unit.

The surface protective layer is a layer disposed on an outermost surface when disposed on the image display device. The surface protective layer may be composed only of a polymer film or a glass plate, or may be composed of plural layers together with the other layer. The surface protective layer is not particularly limited as long as it has hitherto been used as a protective film of the image display device and, for example, it may be an acrylic resin film made of polymethyl methacrylate (PMMA), a polycarbonate resin film, or a glass plate. The thickness of the film or glass plate is not particularly limited and is usually from 0.1 to 5 mm.

When the surface protective layer is a laminate composed of plural layers, it is possible to provide a layer for imparting functions and characteristics such as abrasion resistance, scratch resistance, antifouling properties, anti-reflective properties and antistatic properties on the side of an observer of the image display device. The layer for imparting abrasion resistance and scratch resistance can be formed by applying a curable resin composition capable of forming a hard coat and curing the curable resin composition. For example, a cured coating film can be formed by applying a coating material including a partial condensation reaction product of a silane mixture containing an alkyltrialkoxysilane as a main component and colloidal silica, curing the coating material with heating to form a cured coating film, or applying a coating material containing a polyfunctional acrylate as a main component and irradiating the coating film with ultraviolet ray. In order to secure antifouling properties, a resin layer containing an organic silicon compound or a fluorine-based compound can be formed. In order to obtain antistatic properties, a resin layer containing a surfactant and conductive fine particles. It is preferred that the layer for imparting these functions and characteristics does not adversely affect transparency of the surface protective layer and is thin as possible as long as functions can be exerted. The layer for imparting functions and characteristics is not particularly limited and usually has a thickness within a range from 0.05 to 10 μm.

When the surface protective layer is a laminate composed of plural layers, additional layers such as printed layer, hard coat layer and depositing layer may be included in the entire or partial region of the surface protective layer at the side of a transparent adhesive sheet. When these additional layers are formed at the partial region of the surface protective layer, the surface protective layer serves as a surface having an irregular shape. The thickness of the surface protective layer is usually from 0.1 to 6 mm in total, including these additional layers. When the additional layer is a printing layer or depositing layer to be used as a light shielding layer described hereinafter, the thickness of the layer is usually 10 μm or less. In another form, the thickness of the layer is usually 100 μm or less or 50 μm or less.

FIG. 1 shows a sectional view of one aspect of an image display device including the above transparent adhesive sheet. An image display device 10 has a structure in which a transparent adhesive sheet 3 and a surface protective layer 4 are laminated in this order on a display surface of an image display unit 1. The surface protective layer 4 is composed of a continuous layer 5, and a light shielding layer 6 provided at a partial region in the underside (the side of the transparent adhesive sheet 3) of the continuous layer 5, and a surface has an irregular shape. The light shielding layer 6 is formed by applying a solution prepared by mixing a coating solution of a curable resin composition with a colorant to a predetermined region of the continuous layer 5 using a suitable method such as screen printing and curing the solution using a suitable curing method such as UV irradiation. The transparent adhesive sheet 3 is applied to the side of a surface having an irregular shape of the surface protective layer 4. Since the transparent adhesive sheet 3 has flexibility, internal residual stress of the sheet itself is relaxed even when the surface protective layer 4 has an irregular shape and also a layer with a surface having an irregular shape (for example, polarizing plate) is provided on a display surface of an image display unit, and thus display unevenness in the image display device can be prevented. Since the transparent adhesive sheet 3 has sufficient adhesion force and hydrophilicity, even under a high-temperature and high-humidity environment, neither bubbles nor peeling occurs, and also no whitening occurs at the interface between a display surface of the image display unit 1 and the transparent adhesive sheet 3, and the intermediate between the transparent adhesive sheet 3 and the surface protective layer 4. The image display device 10 is obtained, for example, by laminating a laminate 2 including the surface protective layer 4 and the transparent adhesive sheet 3 to the display surface of the image display unit 1.

FIG. 2 is a sectional view of another aspect in an image display device including the above transparent adhesive sheet. In FIG. 2, an image display device 20 has a structure in which a transparent adhesive sheet 3 and a surface protective layer 4 are laminated in this order on a touch panel 7 existing on a display surface of an image display unit 1. The structure of the laminate 2 in which the transparent adhesive sheet 3 and the surface protective layer 4 are laminated in this order is the same as that described in FIG. 1. The touch panel 7 is disposed on the display surface of the image display unit 1 and an image display in the image display device 20 can be seen through the touch panel. The touch panel 7 is transparent and has a constitution that each transparent conductive layer is disposed on a back surface of two transparent plates made of glass or polyethylene terephthalate (PET) and transparent conductive layers of these transparent plates are disposed in opposite face-to-face arrangement at a distance of microdistance in a non-contact state. When an operator of the tough panel presses the corresponding position of a surface of one transparent plate by a finger or a pen, a transparent conductive layer at a back surface of one transparent plate is contacted with a transparent conductive layer of the other transparent plate, leading to a conductive state only at the corresponding position. When the position in the conductive state is electrically sensed by a sensor, the position pressed by the operator on the touch panel can be specified. Such a touch panel type display is used in portable telephone assistants of PC(s) (personal computers), portable telephones and PDA(s). Since the transparent adhesive sheet 3 has sufficient adhesion force and hydrophilicity, even under a high-temperature and high-humidity environment, neither bubbles nor peeling occurs, and also no whitening occurs at the interface between the touch panel 7 and the transparent adhesive sheet 3, and the intermediate between the transparent adhesive sheet 3 and the surface protective layer 4. The image display device 20 is obtained, for example, by laminating the laminate 2 including the surface protective layer 4 and the transparent adhesive sheet 3 to the touch panel 7 existing to the display surface of the display unit 1.

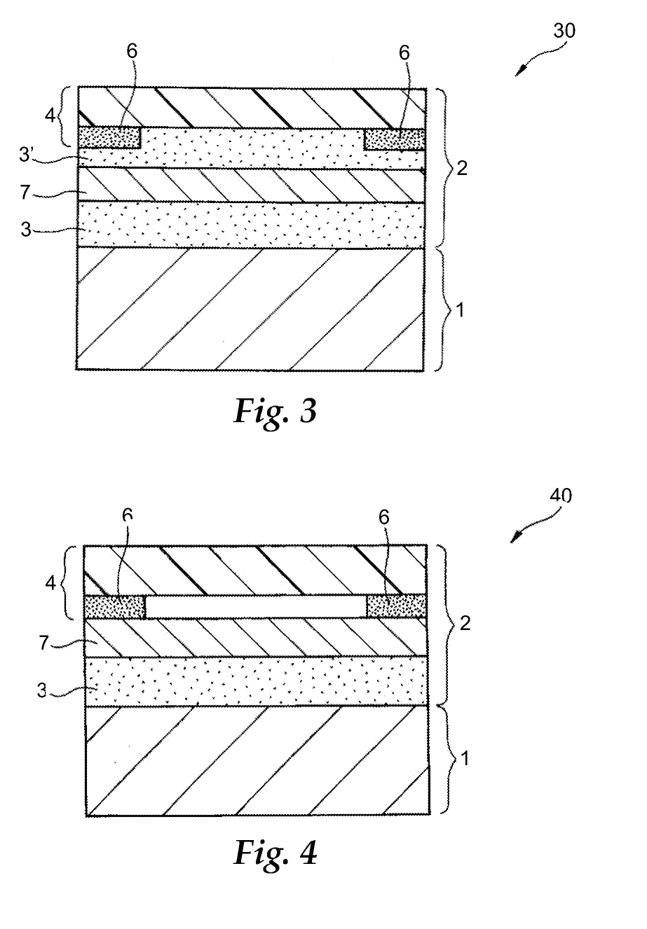

FIG. 3 is a sectional view of still another aspect of an image display device including the transparent adhesive sheet. In FIG. 3, an image display device 30 has a structure in which a transparent adhesive sheet 3, a touch panel 7, a transparent adhesive sheet 3′ and a surface protective layer 4 are laminated in this order on a display surface of an image display unit 1. The structure in which the transparent adhesive sheet 3′ and the surface protective layer 4 are laminated in this order is the same as that described in FIG. 1. The transparent adhesive sheets 3 and the transparent adhesive sheet 3′ may contain the same or different copolymer. Since the transparent adhesive sheets 3 and 3′ have flexibility, even when the surface protective layer 4 has an irregular shape and also a layer with a surface with a surface having an irregular shape (for example, polarizing plate) is provided on a display surface of an image display unit, internal residual stress of the sheet itself is relaxed and thus display unevenness in the image display device can be prevented. Since the transparent adhesive sheets 3 and 3′ have sufficient adhesion force and hydrophilicity, even under a high-temperature and high-humidity environment, neither bubbles nor peeling occurs, and also no whitening occurs at the interface between a display surface of the image display unit 1 and the transparent adhesive sheet 3, and the intermediate between the transparent adhesive sheet 3′ and the surface protective layer 4. The image display device 30 is obtained, for example, by laminating a laminate 2 including the surface protective layer 4, the transparent adhesive sheet 3, the touch panel 7 and the transparent adhesive sheet 3′ to the display surface of the image display unit 1.

FIG. 4 is a sectional view of still another aspect of an image display device including the transparent adhesive sheet. In FIG. 4, an image display device 40 has a structure that a transparent adhesive sheet 3, a touch panel 7 and a surface protective layer 4 are laminated in this order on an image display unit 1. Similar to FIG. 1, the surface protective layer 4 has a light shielding layer 6 in a part of a region and the surface has an irregular shape. The transparent adhesive sheet 3 exists at the side of a surface having an irregular shape of the surface protective layer 4 through the touch panel 7. Since the transparent adhesive sheet 3 has flexibility, internal residual stress of the sheet itself is relaxed even when the surface protective layer 4 has an irregular shape and also a layer with a surface having an irregular shape (for example, polarizing plate) is provided on a display surface of an image display unit, and thus display unevenness in the image display device can be prevented. Since the transparent adhesive sheet 3 has sufficient adhesion force and hydrophilicity, even under a high-temperature and high-humidity environment, neither bubbles nor peeling occurs, and also no whitening occurs at the interface between a display surface of the image display unit 1 and the transparent adhesive sheet 3, and the intermediate between the transparent adhesive sheet 3 and the surface protective layer 4. The image display device 40 is obtained, for example, by laminating a laminate 2 including the surface protective layer 4, the touch panel 7 and the transparent adhesive sheet 3 to the display surface of the image display unit 1.

According to still another aspect of the present disclosure, an electronic device including the image display device is provided. Examples of the electronic device include, but are not limited to, portable telephones, personal digital assistants (PDA), portable game machines, electronic dictionary assistants, car navigation systems, portable music players, clocks, televisions (TV), video cameras, video players, digital cameras, global positioning system (GPS) devices and personal computers (PC).

### EXAMPLES

The present disclosure is described in more detail below by way of Examples, but is not limited to these Examples.

### 1. Method for Preparation of Acrylic Copolymer

### Examples 1 to 19

According to the description shown in Table 1 below, a component (A), a component (B), a component (C) and 0.04 part by mass of IRGACURE™ 651 (2,2-dimethoxy-2-phenylacetophenone) (manufactured by Ciba Japan K.K.) as a photopolymerization initiator were well mixed in a glass container and, after replacing dissolved oxygen by a nitrogen gas, the mixture was partially polymerized by irradiating with ultraviolet ray for several minutes using a low-pressure mercury lamp to obtain a viscous liquid having a viscosity of about 1,500 cP. To the resulting composition, HDDA (1,6-hexanediol diacrylate) as a crosslinking agent and 0.15 part by mass of an additional polymerization initiator (IRGACURE 651) was added, followed by well mixing. The resulting mixture was vacuum-degassed and applied on a 50 μm thick polyester film (release film) subjected to a release treatment in a thickness of 175 μm. In order to remove oxygen which adversely affects the polymerization, the release film was covered, followed by irradiation from both surfaces for about 4 minutes using a low-pressure mercury lamp to obtain a transparent adhesive sheet. According to the following method, tan δ and storage elastic modulus of the resulting film were measured.

### Method for Measurement of Storage Elastic Modulus and Tan δ (Loss Tangent) (Dynamic Viscoelasticity Characteristics)

Production of samples: Cylindrical samples were obtained by removing a release film from the transparent adhesive sheet produced by the above method, laminating 16 sheets to give a 3 mm thick sheet, and punching out using a 7.9 mmφ punching blade.

Measurement: Dynamic viscoelasticity characteristics were measured by using Advanced Rheometric Expansion System (ARES) manufactured by Rheometric Scientific, Ltd. Using a 7.9 mmφ parallel plate as a jig for fixing a sample, each of samples produced by the above method was placed between plates and then a tension was adjusted. Dynamic viscoelasticity characteristics were measured in an air in a shear mode at a frequency of 1.0 Hz, a temperature of −50 to 200° C. and a rate of temperature increase of 5° C./minute, and then a storage elastic modulus G′ (Pa) at 25° C. and tan δ (loss tangent) at 140° C. were determined.

TABLE 1

| | | | | | | | | | | Component (C) |
|---|---|---|---|---|---|---|---|---|---|---|
| | Component (A) | | | | | Component (B) | | | | (Parts by mass) |
| | (Parts by mass) | | | | | (Parts by mass) | | | | (C-1) |
| | 2EHA | ICA | ISA | IBXA | IOA | AA | DAAM | NNDMA | NVP | V#190 |
| Example 1 | 84.0 | | | | | 1.2 | | | | 15.0 |
| Example 2 | 80.0 | | | | | 5.0 | | | | 15.0 |
| Example 3 | 80.0 | | | | | 5.0 | | | | 15.0 |
| Example 4 | 80.0 | | | | | 5.0 | | | | 15.0 |
| Example 5 | 80.0 | | | | | 5.0 | | | | 15.0 |
| Example 6 | 47.0 | 23.0 | | | | 10.0 | | | | 20.0 |
| Example 7 | 70.0 | | 5.0 | | | 5.0 | | | | 20.0 |
| Example 8 | 75.0 | | | 6.0 | | 5.0 | | | | 14.0 |
| Example 9 | 45.0 | | | | | 5.0 | | | | 50.0 |
| Example 10 | 90.0 | | | | | 5.0 | | | | |
| Example 11 | 90.0 | | | | | 5.0 | | | | |
| Example 12 | 75.0 | | | | | 5.0 | | | | |
| Example 13 | 75.0 | | | | | 5.0 | | | | |
| Example 14 | 75.0 | | | | | 5.0 | | | | |
| Example 15 | 80.0 | | | | | | 5.0 | | | 15.0 |
| Example 16 | | | | | 87.5 | 6.0 | | | | |
| Example 17 | | | | | 87.5 | 4.0 | | | | |
| Example 18 | | | | | 87.5 | 10.0 | | | | |
| Example 19 | | | | | 87.5 | 4.0 | | | | |
| Example 20 | | | | | 85.0 | 7.5 | | | | 7.5 |
| Example 21 | | | | | 80.0 | 2.0 | | 6.0 | | |
| Example 22 | 90.0 | | | | | 5.0 | | | | |
| Example 23 | | | | | 90.0 | | | | 4.0 | |
| Example 24 | 88.0 | | | | | 8.0 | | | | |
| Example 25 | 75.0 | | | | | 5.0 | | | | |
| Example 26 | 87.0 | | | | | 9.0 | | | | 4.0 |
| Example 27 | 80.0 | | | | | 5.0 | | | | 15.0 |

| | Component (C) | | | | | | | |
|---|---|---|---|---|---|---|---|---|
| | (Parts by mass) | | | | | | | |
| | (C-1) | | | | | C-2 | | |
| | AM90G | AP150 | DPM-A | EHDG-AT | V#190D | 2-MTA | HPA | HEA |
| Example 1 | | | | | | | | |
| Example 2 | | | | | | | | |
| Example 3 | | | | | | | | |
| Example 4 | | | | | | | | |
| Example 5 | | | | | | | | |
| Example 6 | | | | | | | | |
| Example 7 | | | | | | | | |
| Example 8 | | | | | | | | |
| Example 9 | | | | | | | | |
| Example 10 | 5.0 | | | | | | | |
| Example 11 | | 5.0 | | | | | | |
| Example 12 | | | 20.0 | | | | | |
| Example 13 | | | | 20.0 | | | | |
| Example 14 | | | | | 20.0 | | | |
| Example 15 | | | | | | | | |
| Example 16 | | | | | | | | 6.5 |
| Example 17 | | | | | | | | 8.5 |
| Example 18 | | | | | | | | 2.5 |
| Example 19 | | | | | | | 8.5 | |
| Example 20 | | | | | | | | |
| Example 21 | | | | | | | | 12.0 |
| Example 22 | | | | | | | | 5.0 |
| Example 23 | | | | | | | | 6.0 |
| Example 24 | | | | | | | | 4.0 |
| Example 25 | | | | | | 20.0 | | |
| Example 26 | | | | | | | | |
| Example 27 | | | | | | | | |

| | Initiator | Crosslinking agent | Additional initiator | Storage elastic | |
|---|---|---|---|---|---|
| | (Parts by mass) | (Parts by mass) | (Parts by mass) | modulus | Tanδ |
| | Irg651 | HDDA | Irg651 | ×10⁴ [Pa] (25° C.) | (140° C.) |
| Example 1 | 0.04 | 0.025 | 0.15 | 2.7 | 0.40 |
| Example 2 | 0.04 | 0.000 | 0.15 | 4.3 | 0.60 |
| Example 3 | 0.04 | 0.025 | 0.15 | 4.6 | 0.34 |
| Example 4 | 0.04 | 0.080 | 0.15 | 5.3 | 0.17 |
| Example 5 | 0.04 | 0.100 | 0.15 | 5.1 | 0.13 |
| Example 6 | 0.04 | 0.025 | 0.15 | 6.2 | 0.44 |
| Example 7 | 0.04 | 0.025 | 0.15 | 4.3 | 0.38 |
| Example 8 | 0.04 | 0.025 | 0.15 | 4.8 | 0.35 |
| Example 9 | 0.04 | 0.025 | 0.15 | 3.3 | 0.24 |
| Example 10 | 0.04 | 0.025 | 0.15 | 4.2 | 0.58 |
| Example 11 | 0.04 | 0.025 | 0.15 | 4.6 | 0.15 |
| Example 12 | 0.04 | 0.025 | 0.15 | 4.4 | 0.24 |
| Example 13 | 0.04 | 0.025 | 0.15 | 3.7 | 0.27 |
| Example 14 | 0.04 | 0.025 | 0.15 | 3.1 | 0.33 |
| Example 15 | 0.04 | 0.025 | 0.15 | 2.6 | 0.45 |
| Example 16 | 0.04 | 0.100 | 0.10 | 7.4 | 0.17 |
| Example 17 | 0.04 | 0.100 | 0.10 | 6.3 | 0.18 |
| Example 18 | 0.04 | 0.100 | 0.10 | 8.9 | 0.14 |
| Example 19 | 0.04 | 0.100 | 0.10 | 8.0 | 0.23 |
| Example 20 | 0.04 | 0.100 | 0.10 | 5.4 | 0.20 |
| Example 21 | 0.04 | 0.100 | 0.10 | 7.9 | 0.20 |
| Example 22 | 0.04 | 0.100 | 0.10 | 5.0 | 0.21 |
| Example 23 | 0.04 | 0.100 | 0.10 | 3.9 | 0.17 |
| Example 24 | 0.04 | 0.040 | 0.15 | 7.4 | 0.38 |
| Example 25 | 0.04 | 0.025 | 0.15 | 5.7 | 0.48 |
| Example 26 | 0.04 | 0.025 | 0.15 | 9.0 | 0.34 |
| Example 27 | 0.04 | 0.125 | 0.15 | 4.3 | 0.10 |

Component (A)
2EHA: 2-ethylhexyl acrylate (manufactured by Nippon Shokubai Co., Ltd.)
ICA: Isocetyl acrylate (manufactured by Toho Chemical Industry Co., Ltd.)
ISA: Isostearyl acrylate (manufactured by Shin-nakamura Chemical Corporation)
IBXA: Isobornyl acrylate (manufactured by Osaka Organic Chemical Industry Ltd.)
IOA: Isooctyl acrylate (manufactured by 3M Ltd.)
Component (B)
AA: Acrylic acid (manufactured by TOAGOSEI CO., LTD.)
DAAM: DIACETONE ACRYLAMIDE (manufactured by Nippon Kasei Chemical Co., Ltd.)
NNDMA: N,N-dimethylacrylamide (manufactured by KOHJIN Co., Ltd.)
NVP: N-vinyl pyrrolidone (manufactured by TOAGOSEI CO., LTD.)
Component (C)
V#190: Ethoxyethoxyethyl acrylate (manufactured by Osaka Organic Chemical Industry Ltd.) CH₂═CHCOO—(CH₂CH₂O)₂—CH₂CH₃
AM90G: Methyl polyethylene glycol acrylate (manufactured by Shin-nakamura Chemical Corporation) CH₂═CHCOO—(CH₂CH₂O)ₙ—CH₃ n = 9
AP150: Tripropylene glycol acrylate (manufactured by NOF CORPORATION)
DPM-A: Methyl dipropylene glycol acrylate (manufactured by KYOEISHA CHEMICAL Co., LTD.)
EHDG-AT: 2-ethylhexyl diethylene glycol acrylate (manufactured by KYOEISHA CHEMICAL Co., LTD.)
V#190D: Ethyldiethylene glycol origoacrylate (manufactured by Osaka Organic Chemical Industry Ltd.) Mixture of CH₂═CHCOO—(CH₂CH₂O)₂—CH₂CH₃ and CH₂═CHCOO—(CH₂CH₂COO)ₘ—(CH₂CH₂O)₂—CH₂CH₃ in ratio of 25:75
2-MTA: Methoxyethyl acrylate (manufactured by Osaka Organic Chemical Industry Ltd.)
HPA: 2-hydroxypropyl acrylate (manufactured by Osaka Organic Chemical Industry Ltd.)
HEA: 2-hydroxyethyl acrylate (manufactured by Osaka Organic Chemical Industry Ltd.)
Crosslinking agent
HDDA: 1,6-hexanediol diacrylate (manufactured by Shin-nakamura Chemical Corporation)
Initiator
IRGACURE651 (Irg651): Photopolymerization initiator (manufactured by Ciba Japan K.K.)

### 2. Method for Evaluation of Transparent Adhesive Sheet

### (1) Stress Relaxation Test (Liquid Crystal Display Unevenness)

For evaluation, the sheets obtained above were laminated and the resulting laminate having a thickness of about 1 mm was cut into specimens of 25 mm×25 mm. After removing a liner from one side of the specimen, the specimen was applied at a distance of about 2 mm from the end of a stainless steel plate (0.5 mm thick, 30×60 mm) washed with methyl ethyl ketone and isopropyl alcohol using a rubber roller. After removing the remaining liner of the specimen, stainless steel plates were similarly laminated with each other so that the portions, on which the tape is not applied, do not overlap. After reciprocally contact-bonding once using a 2 kg rubber roller, an autoclave treatment (50° C., 0.5 MPa, 30 minutes) was carried out. After the treatment, the stainless steel plate was allowed to stand at room temperature for 2 hours or more and sufficiently cooled, and then the measurement was carried out by a tensile testing machine (AG-IS, manufactured by Shimadzu Corporation). The stainless steel plate was clamped by a chuck at both ends (15 mm from the end). The stainless steel plate was tensioned at a rate of 0.2 mm/min until it is deformed by 10% (about 0.1 mm) in a shear direction. Maximum stress and stress (300 seconds after termination) were measured. A ratio of residual stress (after 300 seconds) to maximum stress was determined as stress relaxation (%).

Using the transparent adhesive sheet (175 μm thick) obtained above, an acrylic plate trimmed with about 8 μm thick black printing (MR-200, manufactured by Mitsubishi Rayon Co., Ltd., 45×65 mm in size, 1 mm thick) was contact-bonded with a liquid crystal module in which the entire protective cover has been removed of a commercially available portable telephone (904SH, manufactured by Sharp Corporation). The resulting plate/adhesive sheet/liquid crystal module laminate was placed in an autoclave and then treated at 40° C. and 0.5 MPa for 15 minutes. After display of a white image plane by turning on the power of a portable telephone, unevenness was visually confirmed. As a result, any unevenness was not observed in the sheet (stress relaxation: 45%) of Example 3 and the sheet (stress relaxation: 50%) of Example 24, and also unevenness was not observed in the sheet (stress relaxation: 63%) of Example 27. In contrast, when using the sheet (stress relaxation: 76%) of Example 27, unevenness was clearly observed. Unevenness was also observed in the sheet (stress relaxation: 56%) of Example 26 in which an elastic modulus is 9.0×10⁴ (Pa).

### (2) Reliability Test

A release film of the sheet to be evaluated was removed from one surface and an acrylic plate (MR-200, manufactured by Mitsubishi Rayon Co., Ltd., 1.0 mm thick, 55×85 mm) was applied so as not to allow an air enter using a roller, and then the outwardly extruded portion was removed by a cutter. In contrast, a polarizing plate with an adhesive (manufactured by SANRITZ Corporation) was applied on a 0.55 mm thick float glass (50×80 mm) using a rubber roller. The release film of the adhesive sheet applied on the acrylic plate was removed and then contact-bonded using a rubber roller so as to adhere the adhesive surface to a polarizing plate. The resulting acrylic plate/adhesive sheet/polarizing plate/glass laminate was placed in an autoclave and then subjected to a treatment at 50° C. and 0.5 MPa for 30 minutes. The laminate was taken out from the autoclave, allowed to stand at room temperature for 12 hours and then placed in a thermohygrostat at 65° C. and 90% R Hand 85° C. (dry). After 3 days, the laminate was taken out and then peeling and foaming of the laminate were visually confirmed.

TABLE 2

| | Measurement of stress | | | | | |
|---|---|---|---|---|---|---|
| | relaxation | | | | | |
| | Residual stress | | | | | Adhesive |
| | after 300 | Stress | Reliability test | | Haze | Force |
| | seconds (N) | relaxation (%) | 85° C. | 65° C. × 90% | Value | [N/25 nm] |
| Example 1 | 0.20 | 35 | no foaming | no foaming | — | — |
| Example 2 | 0.29 | 26 | slight peeling | no foaming | — | — |
| Example 3 | 0.49 | 45 | no foaming | no foaming | 0.99 | 21.5 |
| Example 4 | 0.72 | 55 | no foaming | no foaming | — | — |
| Example 5 | 0.89 | 63 | no foaming | no foaming | — | — |
| Example 6 | 0.60 | 46 | no foaming | no foaming | 0.35 | 32.3 |
| Example 7 | 0.46 | 47 | no foaming | no foaming | 0.76 | 18.0 |
| Example 8 | 0.51 | 40 | no foaming | no foaming | — | — |
| Example 9 | 0.48 | 50 | no foaming | no foaming | — | — |
| Example 10 | 0.23 | 32 | no foaming | no foaming | — | — |
| Example 11 | 0.62 | 54 | no foaming | no foaming | 1.25 | 17.1 |
| Example 12 | 0.58 | 49 | no foaming | no foaming | — | — |
| Example 13 | 0.34 | 36 | no foaming | no foaming | — | — |
| Example 14 | 0.35 | 36 | no foaming | no foaming | — | — |
| Example 15 | 0.30 | 44 | no foaming | no foaming | — | — |
| Example 16 | 1.14 | 57 | no foaming | no foaming | 0.23 | 18.2 |
| Example 17 | 1.05 | 55 | no foaming | no foaming | 0.22 | 17.5 |
| Example 18 | 1.47 | 59 | no foaming | no foaming | 0.26 | 22.7 |
| Example 19 | 0.91 | 57 | no foaming | no foaming | 0.47 | 21.9 |
| Example 20 | 0.99 | 57 | no foaming | no foaming | 0.84 | 18.3 |
| Example 21 | 1.32 | 59 | no foaming | no foaming | 1.58 | 16.3 |
| Example 22 | 1.08 | 59 | no foaming | no foaming | 0.41 | 15.8 |
| Example 23 | 0.79 | | no foaming | no foaming | 0.92 | 16.9 |
| Example 24 | 1.07 | 50 | slight foaming | slight | — | — |
| | | | | foaming | | |
| Example 25 | 0.39 | 28 | considerable | considerable | — | — |
| | | | foaming | foaming | | |
| Example 26 | 1.15 | 56 | slight foaming | slight | 0.88 | 15.5 |
| | | | | foaming | | |
| Example 27 | 1.24 | 79 | no foaming | no foaming | — | — |

### (3) Evaluation of Optical Characteristics (Total Light Transmittance and Haze)

Only a release film on one surface among release films existing on both surfaces of the transparent adhesive sheets was removed and the transparent adhesive sheet was applied on an acrylic plate (MR-200, manufactured by Mitsubishi Rayon Co., Ltd., 0.8 mm thick, 55×85 mm) so as not to allow an air enter using a roller, and then the outwardly extruded portion was removed by a cutter. After removing the remaining release film on the transparent adhesive sheet applied on the acrylic plate, the adhesive surface of the transparent adhesive sheet was adhered on the 0.55 mm thick float glass (50×80 mm) and then contact-bonded using a rubber roller. The resulting acrylic plate/adhesive sheet/glass laminate was placed in an autoclave and then subjected to a treatment at 40° C. and 0.5 MPa for 15 minutes. The laminate was taken out from the autoclave, placed in a thermo-hygrostat at a temperature of 60° C. and a relative humidity (RH) of 90%, and allowed to stand for 3 days. The laminate was then taken out, and the haze value of the resulting laminate were measured according to JIS K 7136 using NDH2000 manufactured by Nippon Denshoku Industries Co., Ltd.

### (4) Adhesion Force

Each of the transparent adhesive sheets were cut into pieces measuring 25×70 mm using a cutter and, after removing a release film on one surface among release films existing on both surfaces of the transparent adhesive sheets, a 25μ thick polyester film (S-25, manufactured by UNITIKA. LTD.) which was cut into pieces measuring 30×150 mm and coated with a primer (N-200, manufactured by Sumitomo 3M Ltd.) was applied. After removing the remaining release film of the transparent adhesive sheet, the transparent adhesive sheet was applied on a 1 mm thick acrylic plate (MR-200, manufactured by Mitsubishi Rayon Co., Ltd.) using a 2 kg rubber roller. After subjecting to a treatment at 40° C. and 0.5 MPa for 15 minutes in the autoclave and standing at room temperature for 12 hours, a polyester film was tensioned at a peeling rate of 300 mm/min using a tensile testing machine (AG-IS, manufactured by Shimadzu Corporation thereby measuring a 90 degree peeling force of the transparent adhesive sheet.

1. A transparent adhesive sheet for applying a surface protective layer or a touch panel in an image display device to a display surface of an image display unit, or applying the surface protective layer to the touch panel, wherein
the transparent adhesive sheet contains a copolymer of a monomer comprising:
(A) an alkyl (meth)acrylate having an alkyl group of 4 to 18 carbon atoms,
(B) a polar monomer whose homopolymer has a glass transition temperature (Tg) of 50° C. or higher, and
(C) a (meth)acrylate ester (C-1) represented by the following formula (1), or a hydrophilic monomer (C-2) whose homopolymer has a glass transition temperature (Tg) of 10° C. or lower (which is a monomer other than the component (C-1) and a mass ratio of the component (B) to the component (C-2) is from 4:10 to 4:1):
CH₂═C(R)COO-(AO)ₚ—(BO)_{q}—R′ (1)
wherein, in the formula (1),
A is at least one kind of a group selected from the group consisting of (CH₂)ᵣCO, CH₂CH₂, CH₂CH(CH₃) and CH₂CH₂CH₂CH₂,
B is at least one kind of a group selected from the group consisting of (CH₂)ᵣCO, CO(CH₂)ᵣ, CH₂CH₂, CH₂CH(CH₃) and CH₂CH₂CH₂CH₂,
R is a hydrogen or CH₃
R′ is hydrogen, or a substituted or unsubstituted alkyl or aryl group,
p, q and r each represents an integer of 1 or more, and wherein the copolymer exhibits tan δ of 0.13 or more at 140° C. and 1.0 Hz, and also exhibits a storage elastic modulus of 8.9×10⁴ Pa or less at 25° C. and 1.0 Hz.

2. The transparent adhesive sheet according to claim 1, wherein the component (C) is a component (C-1).

3. The transparent adhesive sheet according to claim 2, wherein the component (C-1) is a polyalkylene glycol alkyl ether acrylate of the formula (1) in which R is hydrogen, R′ is an alkyl group having 1 to 12 carbon atoms, and 2≦p+q≦10.

4. The transparent adhesive sheet according to claim 1, wherein the component (B) is an acrylic acid or substituted acrylamide.

5. The transparent adhesive sheet according to claim 1, which is applied to the side of a surface having an irregular shape of a surface protective layer whose one surface has an irregular shape.

6. An image display device comprising an image display unit, the transparent adhesive sheet according to claim 1, and a surface protective layer.

7. The image display device according to claim 6, wherein internal residual stress in the transparent adhesive sheet is relaxed.
